(19) United States
(12) Patent Application Publication
(10) Pub. No.: US 2010/0211561 A1
(43) Pub. Date: Aug. 19, 2010

(54) PROVIDING REPRESENTATIVE SAMPLES WITHIN SEARCH RESULT SETS

(75) Inventors: KEMP CROCKETT PETERSON, SEATTLE, WA (US); JAMES NICHOLS, BELLEVUE, WA (US); ALFIAN TAN, ISSAQUAH, WA (US); JARED LEE REISINGER, REDMOND, WA (US); TABREEZ GOVANI, SAMMAMISH, WA (US); ANTHONY TRAN, BOTHELL, WA (US); NITIN AGRAWAL, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/371,242

(22) Filed: Feb. 13, 2009

(51) Int. Cl. G06F 17/30

(52) U.S. Cl. 707/722; 707/E17.014; 707/E17.061

(57) ABSTRACT

Systems, methods, and computer storage media having computer-executable instructions embodied thereon that provide representative samples among search result sets are provided. Upon receiving a query, it is recognized whether to present a representative sample, or an indication thereof, along with a search result that relates to the query. Search results related to the query are presented to the user. A portion of the search results might include a representative sample, or an indication thereof. Such a representative sample might summarize a media object(s) associated with the search result presented.

### BACKGROUND

Search engines provide users with search results in response to user queries. In some cases, a search result corresponds with a webpage containing video and/or audio content. Even in instances where a webpage includes video and/or audio content, conventional search engines generally utilize a text description to summarize content associated with the corresponding webpage. Oftentimes, however, such text descriptions are incomplete or inaccurate descriptions of a media object and/or webpage associated therewith.

### SUMMARY

Embodiments of the present invention relate to systems and methods that provide representative samples within search result sets. Utilizing the systems and methods described herein, a representative sample that summarizes a media object, or webpage associated therewith, is provided among search results that relate to a user query. In some embodiments, a representative sample is presented in association with a search result to provide a user with a non-text summary. As such, a user might more readily understand or recognize contents of a media object and/or associated webpage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is an illustrative screen display of an exemplary user interface illustrating a search results page, in accordance with an embodiment of the present invention;

FIG. 3 is a block diagram of an exemplary computing system architecture suitable for use in implementing embodiments of the present invention;

FIG. 4 is a block diagram of an exemplary computer system for use in implementing embodiments of the present invention;

FIG. 5 is a flow diagram showing a first method for providing representative samples within search result sets, in accordance with an embodiment of the present invention; and

FIG. 6 is a flow diagram showing a second method for providing representative samples within search result sets, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer storage media having computer-executable instructions embodied thereon that provide representative samples within search result sets. A representative sample refers to a portion of a media object that represents, describes, summarizes, reflects, characterizes, or otherwise relates to the media object. Such a representative sample can provide a user with a brief overview of the media object or webpage associated therewith.

Accordingly, in one aspect, the present invention is directed to one or more computer storage media having computer-executable instructions embodied thereon for performing a method that provides representative samples among search result sets. The method includes receiving a user query. In response to the user query, a set of search results is presented. The set of search results includes a first search result corresponding with a first webpage. The first search result includes a representative sample indicator that, if selected by a user, initiates a presentation of a representative sample that summarizes a media object associated with the first search result. The representative sample is presented within the set of search results. The set of search results also includes a second search result corresponding with a second webpage. The second search result excluding any representative sample indicators.

In another aspect, the present invention is directed to a computerized method that provides representative samples among search result sets. The method includes referencing a webpage having a media object associated therewith. A determination is made as to whether the primary purpose of the webpage is to present the media object. If the primary purpose of the webpage is to present the media object, in response to a user query, a search result is presented that corresponds with the webpage. The search result includes a representative sample of the media object that summarizes the media object associated with the webpage. If the primary purpose of the webpage is not to present the media object, in response to the user query, a search result corresponding with the webpage is presented. Such a search result does not include a representative sample of the media object.

In yet another aspect, the present invention is directed to one or more computer storage media having computer-executable instructions embodied thereon that provides representative samples among search result sets. The method includes obtaining a search query. It is determined that a primary purpose of a first webpage related to the search query is to present a media object associated with the webpage and that it is not the primary purpose of a second webpage related to the search query to present a media object associated with the second webpage. A set of search results is presented. The set of search results includes a first search result in association with the first webpage that includes a text summary and a representative sample indicator comprising a static image. If the representative sample indicator is hovered over, a presentation of a representative sample that summarizes the first media object is initiated. The representative sample is presented within the set of search results. The set of search results also includes a second search result in association with the second webpage. The second search result includes a text summary and excludes any representative sample indicators.

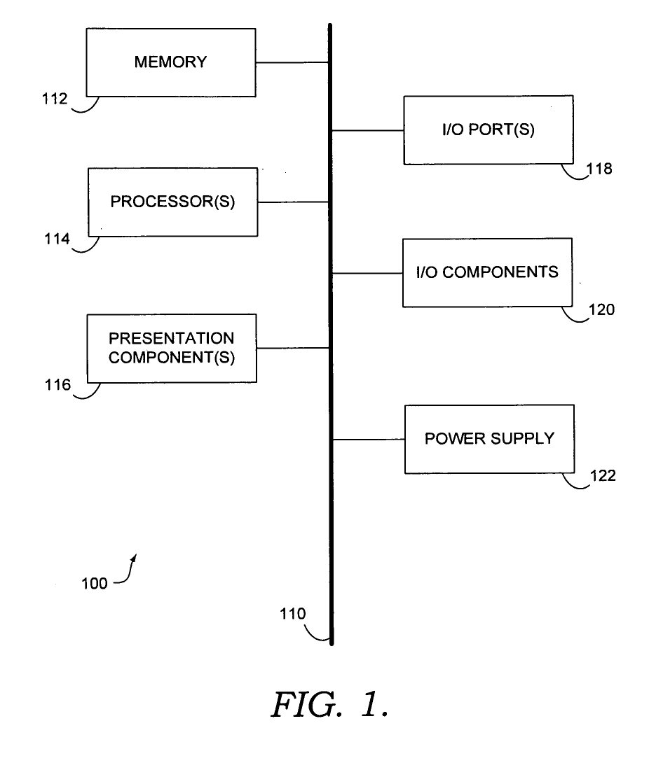

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously set forth, embodiments of the present invention relate to computing systems and methods for providing representative samples, or an indication thereof, within search result sets. As used herein, a representative sample refers to a representation of a media object such that the representation summarizes, reflects, characterizes, describes, or otherwise relates to the media object. Accordingly, a representative sample is a portion of a media object that summarizes or describes a particular media object. In embodiments, a representative sample is a non-text representative sample. A non-text representative sample represents or summarizes a media object via a non-text method. For example, such a representative sample might be a video representative sample, an audio representative sample, an animated representative sample, or a combination thereof, that summarizes a media object. In some cases, a non-text representative sample represents or summarizes a media object using a non-text method, such as video and/or audio, even though the non-text method is associated with text. By way of example, a video and/or audio clip can be a non-text representative sample even though the video might present text phrases therein or have metadata associated therewith.

A media object refers to any media content (e.g., digital content or analog content) including, but not limited to, a video, a song, a movie, a game, a clip, an animation, or any other type of media content. As such, a media object can be, for example, an audio media object, a video media object, a combination thereof, or the like. In embodiments, a media object is a non-text media object (e.g., a video, an audio, or a combination thereof) comprising non-text media content.

Accordingly, a representative sample representing a video object may include, for example, a short video clip or trailer relative to a longer video or movie. A representative sample representing an audio media object may include, for example, a short audio sample relative to a longer song or other audio recording. In one embodiment, the representative sample is intended to summarize the media object. As such, a user can identify whether the media object is of interest to the user. Additionally or alternatively, the representative sample might be intended to summarize the webpage content of which the media object is included or associated. In such a case, a user can identify whether the webpage is of interest to the user.

A representative sample might be a single snippet or segment of a media object. For example, assume a video is five minutes in length. A representative sample of the media object might be thirty seconds in duration beginning at two minutes from the beginning of the video. Alternatively, a representative sample might include multiple snippets or segments of a media object. For instance, assume again that a video is five minutes in length. A representative sample of the media object might be a ten second clip of video beginning at one minute into the video in combination with a ten second clip at two and a half minutes into the video and a five second clip at three and a half minutes into the video. In such a case where multiple snippets from various points of a media object are combined to generate a representative sample, key frames or segments of a media object might be automatically recognized and used to generate the representative sample.

A search results set, as used herein, refers to a list of webpages that correspond with a query, or a portion thereof. In this regard, a search results set lists webpages returned by a search engine in response to a keyword query. A search results set might also be referred to herein as a search results page. Accordingly, a search results set or a search results page contains a plurality of search result listings or search results. A search result or search result listing refers to a listing of a webpage associated with content related to a query. A search result listing or search result might include features such as a title that identifies a webpage, a link to the webpage, a text summary that summarizes or describes at least a portion of the content of a webpage (e.g., text, media objects, etc.), or the like. As discussed more fully below, a search result listing might also include a representative sample and/or a representative sample indicator that indicates a representative sample. Such a representative sample and/or representative sample indicator might be positioned near or adjacent to the title, link, and/or text summary that corresponds with the search result. Generally, search result listings are listed in order of relevance, popularity, or authoritativeness relative to a query, such as a query entered by a user. As such, a search result listing presented above or higher than other search result listings might be identified by a search engine as most likely to provide content being sought by a user.

In some instances, although a user is generally presented with search results that each include a text summary summarizing content of a webpage and/or a media object(s) associated therewith, the user may desire to be presented with a representative sample of a media object(s) associated with the webpage. That is, a user may wish to view and/or listen to a representative sample of a media object(s) associated with a webpage. The presentation of a representative sample may be desired, for example, so that a user can recognize a media object, or content thereof, and determine whether to navigate to view or listen to that particular media object; so that a user can generally recognize content of a webpage and determine whether to navigate to the webpage; or the like.

In various embodiments, a user may view and/or listen to a representative sample and, thereafter, continue perusing search results. That is, a user might be presented with a representative sample within a search results set to obtain a non-textual summary of a media object, or webpage content associated therewith, while maintaining a view of other search result listings returned in response to a query. As such, the user can attain an understanding of webpage content or a media object associated with the webpage without navigating away from the search results page. Accordingly, if the representative sample is unsatisfactory or uninteresting to a user, the user can simply view other search result listings (e.g., search result listings containing a representative sample and/or search results listings without a representative sample) without having to navigate or link to a media object, or webpage associated therewith, and thereafter return to the initial search results page.

By way of example only, assume a user enters a query to locate information pertaining to a specific topic. Further assume that the user is presented with a search results page that contains a plurality of search result listings, wherein some of the search result listings include a representative sample indicator while other search result listings do not include a representative sample indicator. That is, some search result listings have an indication that a user may view and/or listen to a representative sample in association with the search result. For the search result listings that have a representative sample indicator, the user can select the representative sample indicator and thereby view the representative sample while remaining within the search results page. Such a representative sample can provide a non-textual summary that can offer a user another summary of a webpage or media object associated therewith. Such a non-text summary (e.g., a video and/or audio summary) can oftentimes provide a user with more information or more readily identifiable information than can be obtained by a text summary or description.

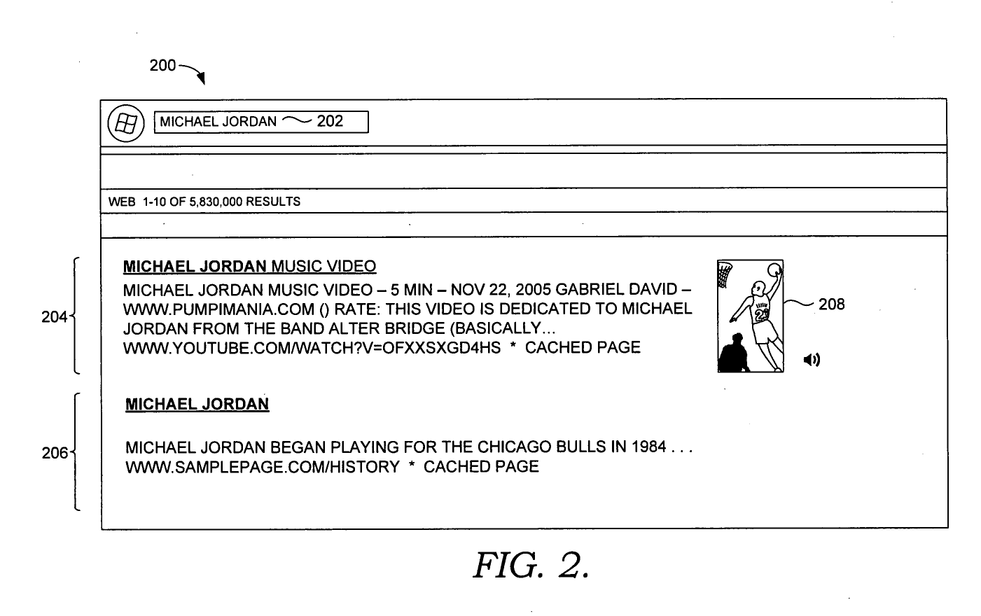

For instance, with reference to FIG. 2, a search results page, generally depicted by reference numeral 200, is shown, in accordance with an embodiment of the present invention. The search results page 200 is provided in response to a user search query 202. The search results page 200 includes search result listing 204 and search result listing 206. Search result listing 204 includes a representative sample indicator 208, while search result listing 206 does not include a representative sample indicator. A user can select or hover over representative sample indicator 208 to be presented with the representative sample. Upon such a selection, the representative sample is presented to the user within the context of search results page 200. That is, the user is not required to navigate or link away from the search results page 200 to view the representative sample. For example, such a representative sample might be presented at or near the location of the representative sample indicator 208. As such, while the representative sample is being presented or upon presentation of the representative sample, the user can view other search result listings without being required to return to the initial search results page 200. It can be appreciated that, in some embodiments, a representative sample might be viewed by way of linking to the representative sample such that the representative sample is presented within another window or upon navigating to another webpage.

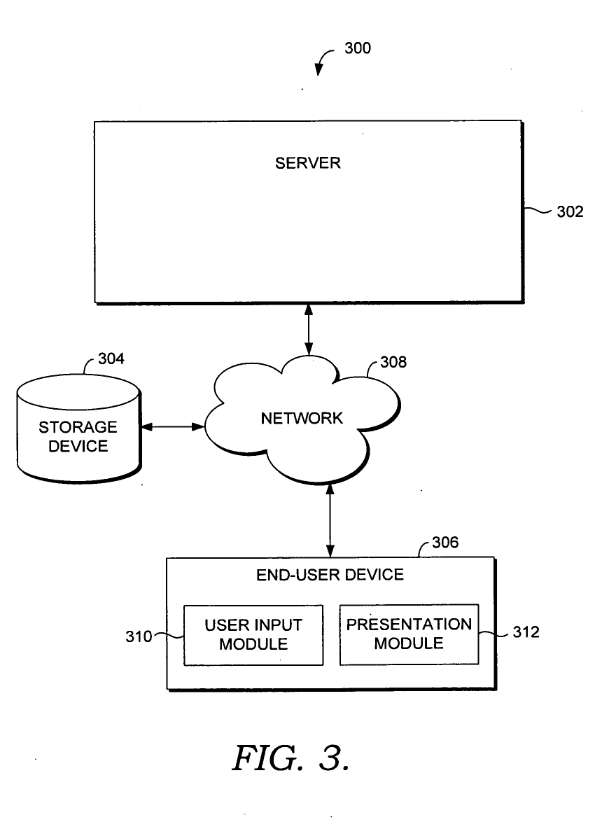

With reference to FIG. 3, a block diagram is illustrated that shows an exemplary computing system architecture 300 configured for use in implementing embodiments of the present invention. It will be understood and appreciated by those of ordinary skill in the art that the computing system architecture 300 shown in FIG. 3 is merely an example of one suitable computing system and is not intended to suggest any limitation as to the scope of use or functionality of the present invention. Neither should the computing system architecture 300 be interpreted as having any dependency or requirement related to any single module/component or combination of modules/components illustrated therein.

Computing system architecture 300 includes a server 302, a storage device 304, and an end-user device 306, all in communication with one another via a network 308. The network 308 may include, without limitation, one or more local area networks (LANs) and/or wide area networks (WANs). Such networking environments are commonplace in offices, enterprise-wide computer networks, intranets and the Internet. Accordingly, the network 308 is not further described herein.

The storage device 304 is configured to store information associated with search results, representative samples, or the like. In various embodiments, such information may include, without limitation, domains, URLs, webpages, websites, representative samples, media objects, information associated therewith, and the like. In embodiments, the storage device 304 is configured to be searchable for one or more of the items stored in association therewith. It will be understood and appreciated by those of ordinary skill in the art that the information stored in association with the storage device 304 may be configurable and may include any information relevant to search results, representative samples, or the like. The content and volume of such information are not intended to limit the scope of embodiments of the present invention in any way. Further, though illustrated as a single, independent component, the storage device 304 may, in fact, be a plurality of storage devices, for instance a database cluster, portions of which may reside on the server 302, the end-user device 306, another external computing device (not shown), and/or any combination thereof.

Each of the server 302 and the end-user device 306 shown in FIG. 3 may be any type of computing device, such as, for example, computing device 100 described above with reference to FIG. 1. By way of example only and not limitation, each of the server 302 and the end-user device 306 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The server 302 may include any type of application server, database server, or file server configurable to perform the methods described herein. In addition, the server 302 may be a dedicated or shared server. One example, without limitation, of a server that is configurable to operate as the server 302 is a structured query language (“SQL”) server executing server software such as SQL Server 2005, which was developed by the Microsoft® Corporation headquartered in Redmond, Wash.

Components of server 302 (not shown for clarity) may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via a network, e.g., network 308. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 300 is merely exemplary. While the server 302 is illustrated as a single unit, one skilled in the art will appreciate that the server 302 is scalable. For example, the server 302 may in actuality include a plurality of servers in communication with one another. Moreover, the storage device 304 may be included within the server 302 or end-user device 306 as a computer-storage medium. The single unit depictions are meant for clarity, not to limit the scope of embodiments in any form.

As shown in FIG. 3, the end-user device 306 includes a user input module 310 and a presentation module 312. In some embodiments, one or both of the modules 310 and 312 may be implemented as stand-alone applications. In other embodiments, one or both of the modules 310 and 312 may be integrated directly into the operating system of the end-user device 306. It will be understood by those of ordinary skill in the art that the modules 310 and 312 illustrated in FIG. 3 are exemplary in nature and in number and should not be construed as limiting. Any number of modules may be employed to achieve the desired functionality within the scope of embodiments hereof.

The user input module 310 is configured for receiving input of one or more queries. Typically, a query is input via a user interface (not shown) associated with the end-user device 306, or the like. Upon receiving input of query terms, the presentation module 312 of the end-user device 306 is configured for presenting search results. In one embodiment, the presentation module 312 presents a plurality of search results utilizing a display device associated with the end-user device 306. Embodiments, however, are not intended to be limited to visual display but rather may also include audio presentation, combined audio/video presentation, and the like.

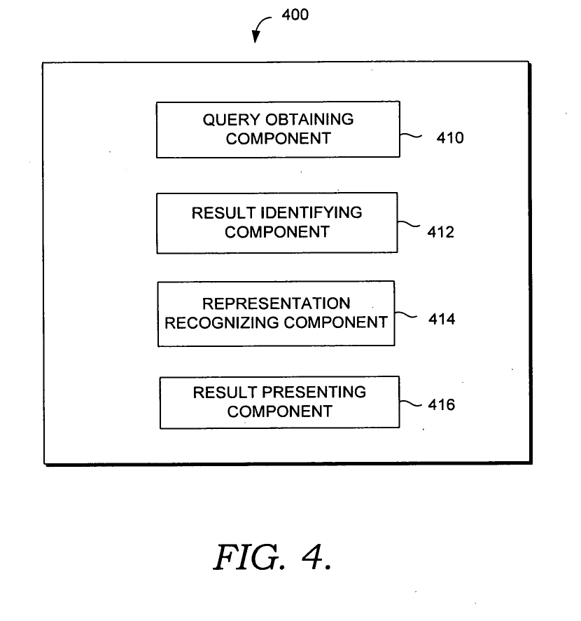

FIG. 4 illustrates an exemplary computing system 400 for providing representative samples, or an indication thereof, within search results sets. As shown in FIG. 4, an exemplary computing system 400 includes a query obtaining component 410, a result identifying component 412, a representation recognizing component 414, and a result presenting component 416. In some embodiments, one or more of the illustrated components may be implemented as stand-alone applications. In other embodiments, one or more of the illustrated components may be integrated directly into the operating system of the server 302, a cluster of servers (not shown) and/or the end-user device 306. It will be understood by those of ordinary skill in the art that the components illustrated in FIG. 4 are exemplary in nature and in number and should not be construed as limiting. Any number of components may be employed to achieve the desired functionality within the scope of embodiments hereof. Further, components may be located on any number of servers or computing devices. By way of example only, result identifying component 412 may reside on a cluster of servers. In such a case, the identified search results may be sent to yet another server networked to an end user.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The query obtaining component 410 is configured for obtaining queries, or portions thereof, i.e., a request for information that may pertain to one or more search terms. A query may be received upon a user inputting one or more terms and, thereafter, selecting a search tool to submit the query, such as an icon, “search” button, or the like. Alternatively, a query may be received upon a user selecting text (e.g., hyperlink or other selectable text) presented on a display associated with the end-user device 206. For example, selectable text may be displayed within a webpage, a menu, a drop-down box, a table of contents, a list, or an index on a website.

The query obtaining component 410 might receive, retrieve, reference, or intercept a query, or a portion thereof. In one embodiment, a query is a user search query. A user search query might be entered by a user into a search engine via a search engine webpage. Such a search engine might be any information retrieval system used to locate information within a computer system (e.g., the World Wide Web or other computer system) and provide search results. As such, in one embodiment, a search engine might be a web search engine that searches the World Wide Web generally based on a user's search query. Such a web search engine may provide search results related to any variety of products, services, information, data, or other information available on the World Wide Web. In this regard, a web search engine provides search results via a search engine webpage that are based generally on the user search query. That is, the web search engine searches the web for mixed content to provide search results related to a query. Mixed content refers to a combination of content types including, but not limited to, text, audio, video, etc. Accordingly, searching the web for mixed content includes searching for more than one type of content such that search results presented to a user can contain various types of content. A web search engine that searches mixed content is not dedicated to only searching for a single content type, such as videos (e.g., a video search engine). By contrast, a video search engine searches the web for a single content type (i.e., video content) to present to a user as search results. Although a video search engine might utilize text (e.g., titles or metadata) to search for videos and/or a video might be associated with a webpage having text, the video search engine is searching the web for video content to present to a user. Searching a webpage having mixed content includes a webpage having a combination of contents, such as text, audio, video, etc.

By way of example only, based on a user search query input into a general search website (e.g., Microsoft's Live.com), a general search engine (Microsoft® Live Search) searches for and provides general search results related to the search query. That is, the search engine results include at least one search result that is not associated with a representative sample (i.e., a non-sample search result) and, in some instances, at least one search result that is associated with a representative sample (i.e., a sample search result). A sample search result refers to a search result corresponding with a representation sample. A non-sample search result refers to a search result that does not correspond with a representation sample, such as a search result having information related to a product or service where no representative sample is available or presented in association therewith.

A user can interact with a search engine in any variety of ways. A user might interact with a search engine in a webpage format. That is, a search engine webpage might be utilized to enter a search query and provide search results. Exemplary search engine and corresponding webpages include, but are not limited to, Microsoft® Live Search accessible via Microsoft's Live.com and MSN.com web portal, Google™ search accessible through Google's google.com web portal, and Yahoo! search accessible through Yahoo's yahoo.com web portal. Alternatively, a user might interact with a search engine in a toolbar format in which a search query entry field is placed on a user's web browser for easier access to the search engine.

The result identifying component 412 is configured for identifying search results. The search results identified may include all relevant search results or a specific portion, e.g., number or percent, of relevant search results. For example, in an embodiment where a specific portion of relevant search results are identified, upon receiving a user query, five million documents may be searched and 15,000 documents may be relevant to the user query. In such a case, although 15,000 relevant search results exist, only the 10,000 most relevant search results may be identified to be presented in response to the user's query.

In one embodiment, the result identifying component 412 identifies search results by either receiving or retrieving search results provided by another server, cluster of servers, user device, or any combination thereof. In some cases, result identifying component 412 may perform search result modifications upon receiving or retrieving relevant search results. For example, the result identifying component 412 may restrict the total number of search results obtained, rank the search results, or the like.

Alternatively, result identifying component 412 identifies desired search results by determining the search results. In such an embodiment, result identifying component 412 searches for and identifies search results. In one embodiment, relevant information may be identified by searching documents (e.g., mixed content, unmixed content, etc.), indices, or a combination thereof. The search results identified by result identifying component 412 may include all relevant search results or a specific number or percentage of relevant search results. In some embodiments, result identifying component 412 may further be configured to organize or restrict search results. For example, search results might be organized by a document ranking based, in part, on the relevance of the document to the query. In addition or in the alternative, the total number of search results might be restricted or limited. In embodiments, as mixed content can be utilized or searched to identify search results, a portion of the search results identified for a particular query might include a representative sample, or an indication thereof, while a portion of the search results identified might exclude a representative sample (e.g., a representative sample is not available or is not desired).

The representation recognizing component 414 is configured to recognize whether to provide or include a representative sample, or an indication thereof, in association with a search result listing. Recognizing whether to provide or include a representative sample, or an indication thereof, in association with a search result listing can be useful for a number of reasons. For example, assume a personal home page includes, among other things, a webpage developer's favorite movie clip. Such a clip, however, might not be relevant to the content of the webpage or the primary purpose of the webpage. Accordingly, providing a representative sample of the movie clip might not provide a search engine user with any valuable information as to whether the webpage associated therewith might be of interest to the user. As such, it might be beneficial to provide a representative sample in association with the search result listing in instances where such a presentation provides value to a user.

In one embodiment, the representation recognizing component 414 makes such a recognition based on the primary purpose of a webpage (i.e., primary page purpose). As such, the representation recognizing component 414, or another component, might determine whether the primary purpose or intent of a webpage is to present or provide a media object(s). That is, the representation recognizing component 414 can make a determination as to whether a media object (e.g., video) is the highly relevant content, important content, primary content, or intended content of a webpage to present to a user. If the primary purpose of a webpage is to provide a media object(s), the representation recognizing component 414 might recognize that a representative sample, or indication thereof, should be provided in association with a search result listing. If, on the other hand, the primary purpose of a webpage is not necessarily to provide a media object(s), the representation recognizing component 414 might recognize that a representative sample, or indication thereof, should not be provided in association with a search result listing.

It can be appreciated that any number of ways can be implemented to make a determination regarding whether the primary purpose of a webpage is to present a media object and, thereby, recognize whether to provide or include a representative sample, or an indication thereof, in association with a search result listing. For example, a uniform resource locator (URL) that corresponds with a webpage can be utilized to determine whether the primary purpose of a webpage is to present a media object. In such a case, a URL, or a portion thereof, in association with a webpage can be referenced to recognize whether the URL indicates that the primary purpose of the webpage is to provide a media object or indicates that a representative sample should be presented along with a search result. Such an indication may be included in a path within a URL. It can be appreciated that a list of URLs can be generated, either manually and automatically, and referenced by the representation recognizing component 414.

In some cases, a webpage can be analyzed to determine whether the primary purpose of the webpage is to present a media object. Accordingly, a webpage might be referenced and analyzed. Such an analysis might include recognizing and analyzing various features of a webpage. Webpage features to analyze might include, for example, the number of media objects included within the webpage, the text content of the webpage, the viewing size of media object(s) included within the webpage, the amount of text on the webpage, anchor text (e.g., incoming anchor text to the webpage), etc. Webpage features can provide an indication of a primary page purpose.

User actions might be analyzed, in some cases, to determine whether the primary purpose of a webpage is to present a media object. Users actions can include, but are not limited to, searches, clicks, navigated to webpages, length of webpage visits, webpages browsed, or the like. Toolbar software, or other software, might be utilized to monitor and/or analyze user actions. By way of example only, in one embodiment, a length of a time a user visits a particular webpage can be detected (e.g., a toolbar software might collect data regarding the length of time a webpage is visited by a user). In such a case, if the length of time the webpage was visited by a user correlates (e.g., to a predetermined extent) with the length of the video, it might be assumed that a user(s) visits the webpage to view the video. Accordingly, it might be determined that the primary purpose of the webpage is to present a media object.

In other cases, a determination as to whether the primary purpose of a webpage is to present the media object might be based on an analysis performed by a search engine associated with a specific content type, such as a video search engine that searches the web for video content. Such a search engine searches the web for a particular type of media content, such as video content, to locate media that would be interesting, available, or relevant to present to a user. A search engine associated with a specific content type generally indexes the media object, or webpage associated therewith, upon analyzing the media content and identifying that such media is sufficiently important to be indexed. In one embodiment, a video search engine is capable of identifying an original source of a video as opposed to sources that have a link to a video or that otherwise embed a video. When a search engine associated with a specific content type will present a media object, or webpage associated therewith, as a search result if relevant to a query (e.g., the media object or webpage is indexed), the representation recognizing component 414 can determine that the primary purpose of a webpage is to present the media object and/or recognize that a representative sample, or indication thereof, should be provided in association with a search result listing.

In some embodiments, the representation recognizing component 414 might alternatively or additionally recognize whether to present a representative sample based on, for example, media object content, user intent, or the like. For example, content of a media object might be analyzed and compared to text content, or other content (e.g., other media objects), of the webpage. In instances where the content of the media object is directed to similar or the same substance as other content of the webpage, it might be assumed that the media object summarizes the webpage content and, as such, a representative sample should be presented in association with a search result directed to that webpage.

By way of further example, a determination of whether to present a representative sample might be based on a query entered by a user (i.e., user preferred or intended search results). In such a case, a query entered by a user can be analyzed to determine whether the user intends to locate a particular type of media, such as a video. For instance, assume that a user types “NBA Basketball video.” In such a case, the representation recognizing component 414, or other component, might recognize that a video is desired. Accordingly, available representative samples might be provided in association with search results notwithstanding the primary purpose of the page.

The representation recognizing component 414 might recognize whether to provide a representative sample with a corresponding search result and/or perform an analysis associated therewith (e.g., primary page purpose analysis, URL analysis, user action analysis, media object analysis, webpage analysis, etc.) dynamically. For example, upon obtaining a user query and/or identifying search results, the representation recognizing component 414 might determine the primary purpose of the webpage (e.g., using any mechanism) and thereafter recognize whether to provide a representative sample, or indication thereof, in association with a search result listing.

Alternatively, the representation recognizing component 414 might recognize whether to provide a representative sample with a corresponding search result and/or perform an analysis associated therewith in advance of a user query and stored in a data store or index, such as storage device 304 of FIG. 3. For example, a data store might identify a webpage, an indication (e.g., yes or no) of whether to provide a representative sample with search results, an indication of whether the primary purpose of the webpage is to present a media object, etc.) In such a case, representation recognizing component 414 might access the data store to recognize whether to provide a sample representation with search results.

The result presenting component 416 is configured to present search results, including representative samples and/or representative sample indicator, where appropriate. Search results may be presented in a variety of forms, e.g., document ranking order, first-in-first-order order, last-in-last-out order, or the like. As can be appreciated, a search results page may be provided in any configuration. In embodiments, the result presenting component 416 presents one or more search result listings via a computing device, such as the end-user device 306 of FIG. 3.

In embodiments, the result presenting component 416 presents a representative sample, or a representative sample indicator, in accordance with the representation recognizing component 414. In this regard, if the representation recognizing component 414 recognizes, identifies, or determines that a search result should be provided in association with a representative sample, or an indication thereof, the result presenting component 416 presents the search result accordingly. On the other hand, if the representation recognizing component 414 recognizes, identifies, or determines that a search result should not be provided in association with a representative sample, or an indication thereof, the result presenting component 416 presents the search result without a representative sample, or an indication thereof.

In cases where a representative sample is presented along with a search result, the presentation thereof can begin at anytime, such as, for example, upon presenting the search results. As such, upon returning search results to a user, any representative samples provided therewith might begin playing. In cases where a representative sample indicator is presented along with a search result, a user may select (e.g., click on, hover over, right click, etc.) a representative sample indicator to view and/or listen to the representative sample. A representative sample indicator might be a still image or other icon (e.g., a play button) that indicates or represents a representative sample. Upon a user selecting a representative sample indicator, the representative sample can be presented to the user. In one embodiment, the representative sample is presented without navigating away from the listing of search results. In another embodiment, the representative sample is presented using a link that navigates away from the listing of search results.

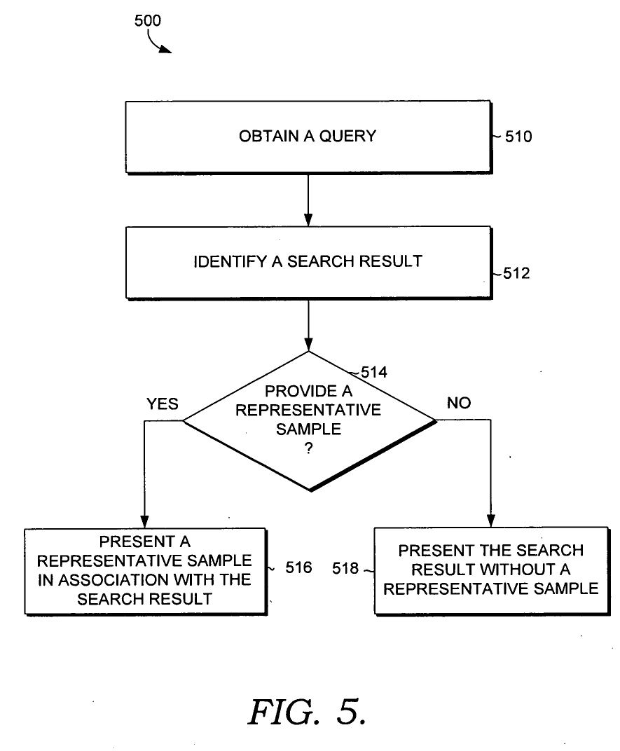

Turning now to FIG. 5, a flow diagram is illustrated which shows a first method 500 for providing representative samples within search result sets, in accordance with an embodiment of the present invention. Initially, at block 510, a query is obtained. At block 512, a search result that relates to the query is identified. It is determined at block 514 whether to provide a representative sample of a media object in association with the search result. In embodiments, such a determination might be made based on a primary purpose of the webpage, user intent, content of the media object, or the like. If it is determined that a representative sample should be provided in association with the search result, a representative sample is presented along with the search result. This is indicated at block 516. If, however, it is determined that a representative sample should not be provided in association with the search result, a representative sample is excluded from being presented with the search result, as indicated at block 518.

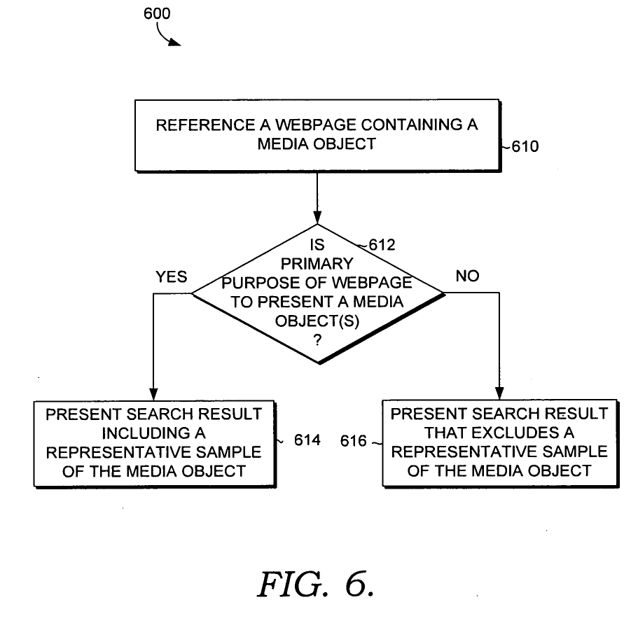

With reference to FIG. 6, a flow diagram is illustrated which shows a second method 600 for providing representative samples within search result sets, in accordance with an embodiment of the present invention. Initially, as indicated at block 610, a webpage containing a media object is referenced. Subsequently, at block 612, it is determined if a primary purpose of the webpage is to present the media object. In embodiments, such a determination might be made using a uniform resource locator, a web feature(s), a user action(s), a video search engine, or a combination thereof. If it is determined that the primary purpose of the webpage is to present the media object, a search result including a representative sample of the media object is presented in response to a user query. This is indicated at block 614. If, on the other hand, it is determined that the primary purpose of the webpage is not to present the media object, a search result that excludes a representative sample of the media object is presented in response to a user query, as indicated at block 616.

It will be understood by those of ordinary skill in the art that the order of steps shown in the method 500 of FIG. 5 and the method 600 of FIG. 6 are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media having computer-executable instructions embodied thereon for performing a method that provides representative samples among search result sets, the method comprising:
receiving a user query; and
in response to the user query, presenting a set of search results having
a sample search result corresponding with a first webpage, the sample search result including a representative sample indicator that, if selected by a user, initiates a presentation of a non-text representative sample that summarizes a media object associated with the sample search result, the non-text representative sample being presented within the set of search results, and
a non-sample search result corresponding with a second webpage, the non-sample search result excluding any representative sample indicators.

2. The one or more computer storage media of claim 1 further comprising recognizing that the representative sample indicator should be presented along with the sample search result.

3. The one or more computer storage media of claim 2, wherein it is recognized that the representative sample indicator should be presented along with the sample search result based on a determination that a primary purpose of the first webpage is to present the media object corresponding with the non-text representative sample.

4. The one or more computer storage media of claim 3, wherein the determination that the primary purpose of the first webpage is to present the media object is based on a uniform resource location associated with the first webpage.

5. The one or more computer storage media of claim 3, wherein the determination that the primary purpose of the first webpage is to present the media object is based on an analysis of web features of the first webpage.

6. The one or more computer storage media of claim 3, wherein the determination that the primary purpose of the first webpage is to present the media object is based on user actions in association with the first webpage.

7. The one or more computer storage media of claim 3, wherein the determination that the primary purpose of the first webpage is to present the media object is based on whether the media object has been indexed by a video search engine.

8. The one or more computer storage media of claim 2, wherein it is recognized that the representative sample indicator should be presented along with the sample search result based on one or more search terms of the user query.

9. The one or more computer storage media of claim 2, wherein it is recognized that the representative sample indicator should be presented along with the sample search result based on whether the representative sample summarizes the first webpage.

10. The one or more computer storage media of claim 1, wherein the media object comprises a video media object, an audio media object, or a combination thereof.

11. A computerized method that provides representative samples among search result sets, the method comprising:
referencing a webpage having a media object associated therewith; and
determining if a primary purpose of the webpage is to present the media object, wherein
if the primary purpose of the webpage is to present the media object, in response to a user query, presenting a first search result corresponding with the webpage including a representative sample of the media object that summarizes the media object associated with the webpage, and
if it is not the primary purpose of the webpage to present the media object, in response to the user query, presenting a second search result corresponding with the webpage without any representative samples of the media object.

12. The computerized method of claim 11, wherein the media object comprises an audio media object, a video media object, or a combination thereof.

13. The computerized method of claim 11, wherein the representative sample is presented upon a user selecting a representative sample indicator that provides an indication of a representative sample.

14. The computerized method of claim 13, wherein the representative sample indicator comprises a still image or other icon.

15. The computerized method of claim 13, wherein the user selects the representative sample indicator by hovering over the representative sample indicator.

16. The computerized method of claim 11, wherein the first search result further includes a text summary.

17. The computerized method of claim 11, wherein the second search result includes a text summary.

18. The computerized method of claim 11, wherein the primary purpose of the webpage is determined using a uniform resource locator, web features, user actions, a video search engine, or a combination thereof.

19. The computerized method of claim 11, wherein the webpage contains a plurality of content types.

20. One or more computer storage media having computer-executable instructions embodied thereon for performing a method that provides representative samples among search result sets, the method comprising:
obtaining a search query;
determining that a primary purpose of a first webpage related to the search query is to present a first media object associated with the first webpage;
determining that it is not the primary purpose of a second webpage related to the search query to present a second media object associated with the second webpage; and
presenting a set of search results having
a first search result in association with the first webpage that includes a text summary and a representative sample indicator comprising a static image that, if hovered over, initiates a presentation of a representative sample that summarizes the first media object associated with the first webpage, the representative sample being presented within the set of search results, and
a second search result in association with the second webpage that includes a text summary and excludes any representative sample indicators.
